(19) United States
(12) Patent Application Publication
(10) Pub. No.: US 2022/0318580 A1
(43) Pub. Date: Oct. 6, 2022

(54) APPARATUS, METHOD, AND STORAGE MEDIUM

(71) Applicant: CANON KABUSHIKI KAISHA, Tokyo (JP)

(72) Inventors: Akihiro Tomida, Kanagawa (JP); Hidehiko Kanda, Kanagawa (JP); Keiji Kuriyama, Saitama (JP); Takayuki Ushiyama, Chiba (JP); Takeshi Yazawa, Kanagawa (JP); Yoshinori Nakajima, Kanagawa (JP)

(21) Appl. No.: 17/702,605

(22) Filed: Mar. 23, 2022

(30) Foreign Application Priority Data
Mar. 31, 2021 (JP) 2021-060647

(51) Int. Cl. G06K 15/10; G06K 15/02

(52) U.S. Cl. CPC G06K 15/107; G06K 15/1881; G06K 15/1878

(57) ABSTRACT

According to an aspect of the embodiments, in multi-tonal image data in which each of pixels is represented by bit data of M bits (M≥2), reduction processing is performed by applying a mask pattern to the bit data to be thinned out without increasing load of calculation processing.

### BACKGROUND

### Technical Field

The aspect of the embodiments relates to an apparatus that records an image on a recording medium, a method, and a storage medium.

### Description of the Related Art

A recording apparatus based on a so-called multipass printing method has been proposed which records an image by performing print scanning multiple times over a unit area on a recording medium using a print head having a discharge opening array in which a plurality of discharge openings for discharging ink are arranged. Recording data corresponding to the print scanning performed multiple times according to the multipass printing method is generated based on image data having 1-bit information indicating discharge or non-discharge of ink for each pixel and a mask pattern having 1-bit information indicating permission or prohibition of the discharge of the ink for each pixel. In recent years, a method of generating recording data, based on image data having multiple-bit information in which the number of ink discharge times can be set in multiple ways for each pixel and in which a plurality of mask patterns having multiple-bit information for setting the number of times to permit the ink discharge for each pixel has also been proposed. According to this method, ink can be applied to a single pixel area multiple times.

Processing for reducing an application amount of ink has been proposed to suppress bleeding of the ink in an edge area or the like of an object. Japanese Patent Laid-Open No. 2005-1190 describes a method of thinning out multivalued data of pixels corresponding to the edge area at a certain ratio, and a method of replacing the multivalued data with data of different dot sizes.

### SUMMARY

According to an aspect of the embodiments, there is provided an apparatus including an identification unit configured to identify, in L-tonal (L 3) image data in which each of pixels is represented by bit data of M bits (M 2), a target pixel on which reduction processing is to be executed, and a reduction processing unit configured to reduce a grayscale value of the identified target pixel, in which the reduction processing unit reduces the grayscale value, based on the bit data of M bits corresponding to the target pixel and mask pattern data corresponding to the target pixel.

Further features of the disclosure will become apparent from the following description of exemplary embodiments with reference to the attached drawings.

### BRIEF DESCRIPTION OF THE DRAWINGS

FIGS. 1A and 1B are schematic diagrams of a recording apparatus and print heads.

FIGS. 2A and 2B are block diagrams of the recording apparatus and a recording control unit.

FIG. 3 is a flowchart of image data processing.

FIG. 4 illustrates a decode table in a multipass mask.

FIGS. 5A and 5B illustrate input multivalued image data of a first embodiment.

FIG. 6 is a flowchart of edge processing of the first embodiment.

FIGS. 7A and 7B illustrate edge areas of black ink data of the first embodiment.

FIGS. 8A, 8B, and 8C illustrate bit data of cyan ink of the first embodiment.

FIGS. 9A and 9B illustrate edge area thinning mask patterns of the first embodiment.

FIG. 10 illustrates the bit data after the edge processing of the cyan ink of the first embodiment.

FIG. 11 illustrates multivalued data after the edge processing of the cyan ink of the first embodiment.

FIGS. 12A and 12B illustrate input multivalued image data of a second embodiment.

FIGS. 13A and 13B illustrate a mask pattern and recording data of the second embodiment.

FIG. 14 is a flowchart of edge processing of the second embodiment.

FIGS. 15A, 15B, and 15C illustrate mask patterns for different grayscale values of the second embodiment.

FIG. 16 illustrates a mask pattern of the second embodiment.

FIGS. 17A and 17B illustrate bit data after the edge processing of the cyan ink of the second embodiment.

FIGS. 18A and 18B illustrate bit data and a mask pattern of a third embodiment.

### DESCRIPTION OF THE EMBODIMENTS

### First Embodiment

Hereinafter, an embodiment of the disclosure will be described with reference to the drawings.

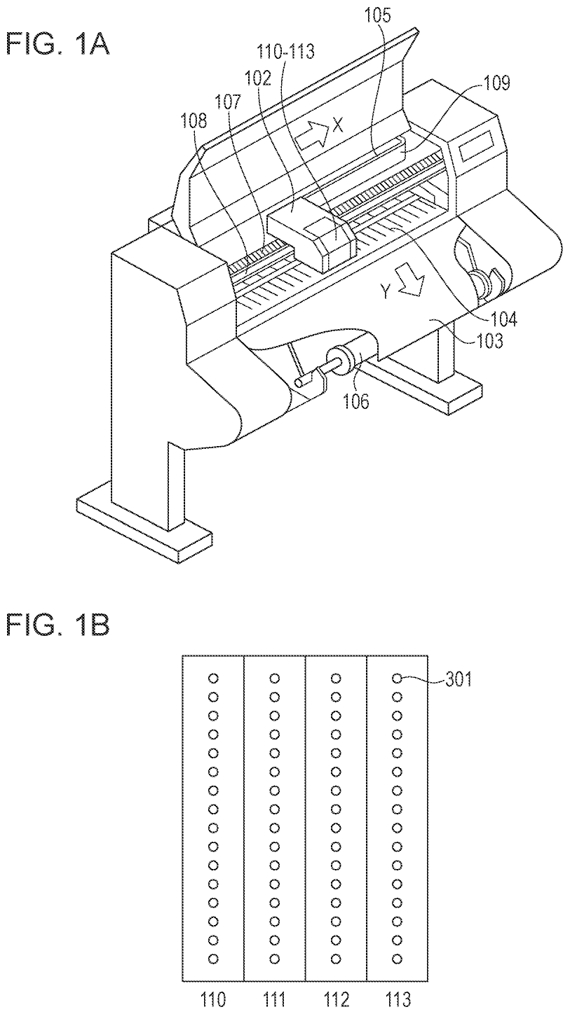

FIG. 1A is a perspective view partially illustrating an internal configuration of an ink jet recording apparatus according to a first embodiment of the disclosure.

A platen 104 is arranged inside the ink jet recording apparatus, and a large number of suction holes (not illustrated) are formed on the platen 104 to suction a recording medium 103 to avoid floating. These suction holes are connected to a duct, and furthermore, a suction fan (not illustrated) is arranged below the duct. When this suction fan operates, the suction of the recording medium 103 is carried out via the platen 104.

A carriage 102 is supported with a main rail 108 installed to extend in a paper width direction and configured to be able to reciprocally move in an X direction (cross direction). Print heads 110 to 113 based on an ink jet method which will be described below are mounted to the carriage 102. The print heads 110 to 113 of the present embodiment are based on a thermal jet method using a heating element as a recording element, but various recording methods such as a piezoelectric method using a piezoelectric transducer can be applied to the print heads. A carriage motor 205 which is not illustrated in FIG. 1A is a drive source for moving the carriage 102 in the X direction, and rotational drive force thereof is transmitted to the carriage 102 by a belt 107.

The recording medium 103 is wound off and fed from a rolled medium and conveyed in a Y direction (conveyance direction) intersecting with the X direction on the platen 104. A leading edge of the recording medium 103 is pinched by pinching rollers (not illustrated) and conveyance rollers (not illustrated), and the conveyance rollers are driven by a conveyance motor 204, so that a conveyance operation is carried out. A mode in which the discharged recording medium 103 is directly discharged to the outside of the apparatus, or a mode in which the discharged recording medium 103 is wound like a roll by a winding apparatus 106 may also be adopted. In addition, the recording medium may be a cut sheet.

FIG. 1B is a schematic diagram illustrating the print heads used in the present embodiment. The print heads 110 to 113 respectively correspond to ink of yellow (Y), magenta (M), cyan (C), and black (Bk) and are aligned and arranged in the X direction in which the carriage scans. A configuration including print heads that discharge ink of photo magenta (Pm), photo cyan (Pc), gray (Gy), photo gray (Pgy), red (R), and blue (B), processing liquid (P) having a purpose other than coloring, such as protection of a recording surface or improvement in gloss uniformity, and the like may also be adopted. In these print heads, 1280 discharge openings 301 which include recording elements for discharging respective types of ink are arranged in the conveyance direction at a density of 1200 dpi. It is noted that a configuration may also be adopted in which discharge openings 301 at positions adjacent to each other in the conveyance direction are arranged at positions shifted to each other in the X direction. The print heads 110 to 113 are connected to a recording control unit 201 of the recording apparatus body via a flexible cable 109. The print heads are not limited to print heads separately formed for the respective ink colors but may be an integrally formed print head.

The discharge openings 301 are connected to respective ink tanks, which are not illustrated in the drawing, housing the corresponding types of ink by tubes 105, and the ink is supplied via the tubes 105. It is noted that the print heads 110 to 113 used in the present embodiment and the ink tanks may be integrally configured or may be configured to be separatable from each other.

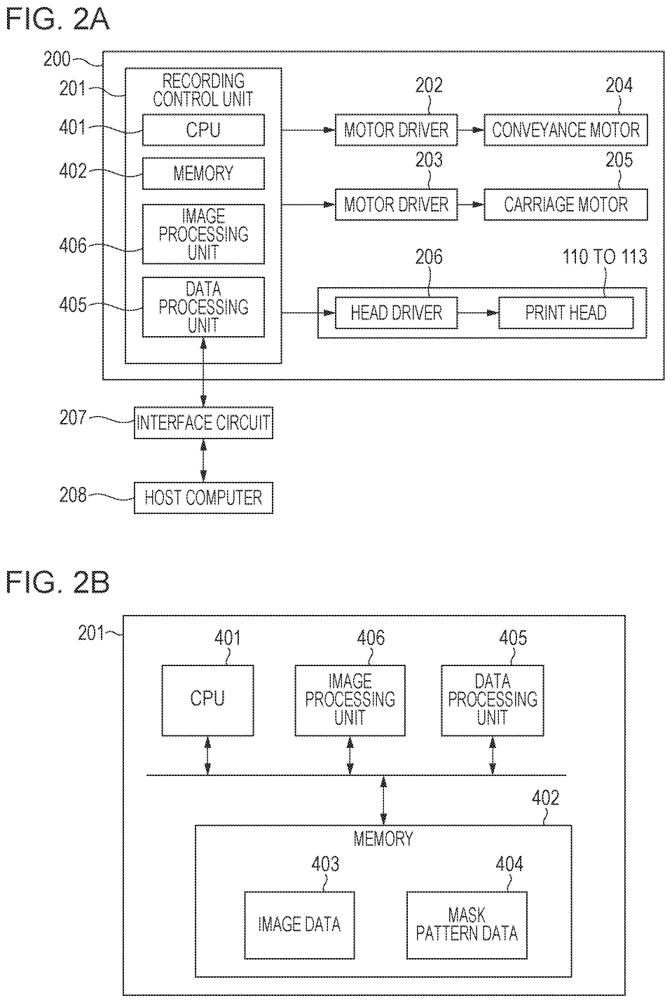

FIG. 2A is a block diagram illustrating a schematic configuration of a control system according to the present embodiment. The recording control unit 201 includes a CPU 401 configured to execute processing operations such as calculation, selection, determination, and control, a memory 402 that stores a control program or the like to be executed by the CPU 401, and the like. The memory 402 stores image data and mask patterns which will be described below, and the like. The recording control unit 201 is connected to a host computer 208 via an interface circuit 207 and configured to receive image data from the host computer 208. In a data processing unit 405 and an image processing unit 406, drive data for the print heads is generated through an image processing flow which will be described below, based on the received image data. The generated drive data (recording data) is sent to the print heads 110 to 113 via a head driver 206.

Each drive circuit, such as the conveyance motor 204 and the carriage motor 205, is connected to the recording control unit 201 via a corresponding motor driver 202 or 203. Each of the motors is driven based on moving distances of the carriage 102 and the recording medium 103 which are instructed from the recording control unit 201, and ink droplets are discharged from the print heads 110 to 113, based on position information of the carriage 102 and the recording medium 103 to record an image on the recording medium 103.

According to the present embodiment, image data having M-bits (M≥2: M is an integer higher than or equal to 2), L-tonal (L≥3) tone information per pixel is generated as the recording data of each of the ink colors. It is noted that in the following description, a case where information of 2 bits per pixel is included as image data indicating a pixel value of each pixel will be described. The M-bit tone information according to the present embodiment may be information for setting the number of ink discharge times to discharge ink droplets with an identical amount to the pixel up to (2\hat{ }M−1) times or may be ink discharge amount information of (2\hat{ }M−1) types where the amount per droplet of the ink droplets varies. According to the present embodiment, the M-bit tone information is information of the number of the ink discharge times which indicates the number of ink droplets to be applied to the pixel. It is noted that when a print head that can discharge ink droplets in a plurality of sizes is used, binarization processing which will be described below can be omitted, and the M-bit, L-tonal image data can be used as the recording data.

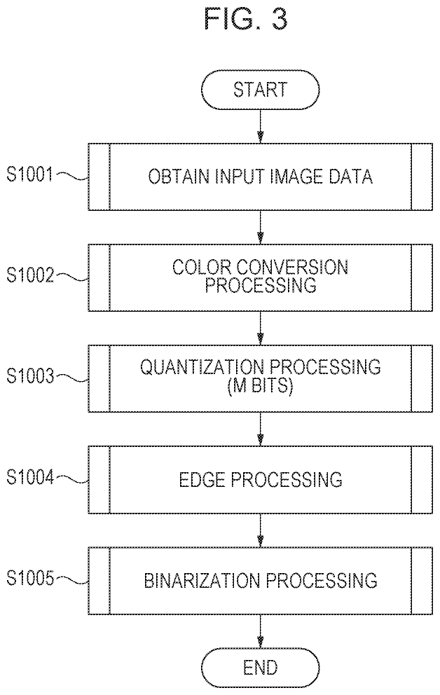

FIG. 3 is a flowchart illustrating processing for generating recording data, based on input image data. In step S1001, the ink jet recording apparatus receives multivalued data in an RGB format or a CMYK format (hereinafter, referred to as image data) which is input from the host computer 208. This image data 403 is held by the memory 402 illustrated in FIG. 2B.

Next, in step S1002, color conversion processing for converting the image data 403 into data corresponding to ink colors used in recording is performed by the CPU 401 and the image processing unit 406. Next, in step S1003, quantization processing based on dithering or error diffusion is performed on the data corresponding to each ink described above by the CPU 401 and the image processing unit 406. With this configuration, multivalued image data of 2 bits indicating a grayscale value of the ink for each of the pixels is generated. In this multivalued image data, any of the pixel values “00”, “01”, “10”, and “11” is set for each of the pixels. It is noted that according to the present embodiment, a flow for executing the quantization processing on data after the color conversion processing will be described, but conversion processing may be performed to generate multivalued data of M bits for each pixel as output data of the color conversion processing.

In step S1004, correction processing for correcting pixel values in an edge area of an image is performed by the CPU 401 and the data processing unit 405. According to the present embodiment, edge processing for correcting image data of chromatic color ink including cyan, magenta, and yellow corresponding to an edge area of the black ink is executed. A detail of this edge processing will be described below.

In step S1005, the binarization processing for generating binary data indicating discharge or non-discharge of the ink for each pixel is performed on the multivalued data after the edge processing which is obtained in step S1004 by the CPU 401 and the data processing unit 405. This binarization processing includes processing for performing resolution conversion on the multivalued data, based on a submatrix pattern, and thinning processing based on a mask pattern. It is however noted that according to the present embodiment, since a resolution of the image data after the quantization processing is the same as a print resolution of the print head, the resolution conversion based on the submatrix pattern is not performed, and the thinning processing on the data after the edge processing is implemented.

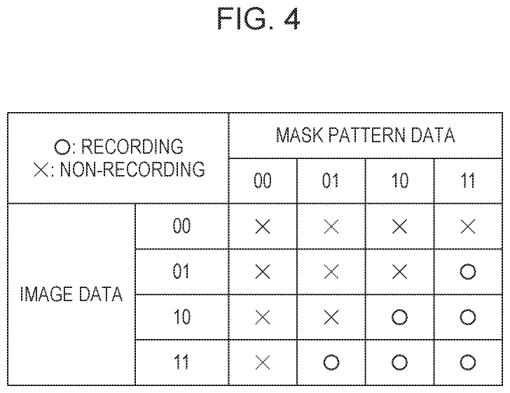

Here, the binarization processing of the present embodiment will be described. Both the image data after the quantization processing and mask pattern data 404 are set as 2-bit data herein. FIG. 4 is a decode table used for the binarization processing. With reference to this decode table, binary data is generated by selecting discharge (recording) or non-discharge (non-recording) of ink for each of the pixels from combinations of the image data and the mask pattern data. In the decode table in FIG. 4, a pixel value at which ink is to be discharged is generated for a pixel with a combination where “◯” is specified, and a pixel value at which ink is not to be discharged is generated for a pixel with a combination where “x” is specified. The binary data generated in the present embodiment is 1-bit data.

In the mask pattern data used in the present embodiment, one of “01”, “10”, and “11” is set at each pixel position of the mask pattern. Thus, in multipass printing, for the image data “01”, since the ink is discharged only when the mask pattern data is “11”, one dot is recorded. In addition, for the image data “10”, since the ink is discharged when the mask pattern data is “10” and “11”, two dots are recorded. Furthermore, for the image data “11”, since the ink is discharged when the mask pattern data is “01”, “10”, and “11”, three dots are recorded. In this manner, one to three dots can be recorded in accordance with the grayscale value of the image data and the mask pattern data.

Next, the edge processing will be described. According to the present embodiment, in each image data of the chromatic color ink including yellow, magenta, and cyan, the correction processing is executed on pixels adjacent to pixels to which the black ink is to be applied. This is for suppressing sharpness reduction due to bleeding of the black ink into an area of the chromatic color ink in the vicinity of an area to which the black ink is applied. When the number of dots of the chromatic color ink to be recorded is decreased in the pixels adjacent to the pixels to which the black ink is to be applied, it is possible to suppress the bleeding of the black ink into the chromatic color area.

It is noted that an area set as a target of the above-described reduction processing for reducing the application amount of the ink is not limited to a chromatic color ink area adjacent to an edge section of the black area. It is sufficient when the target of the reduction processing is selected according to a combination with which the bleeding is conspicuous due to color value difference or surface tension difference of the ink, and a different combination can be appropriately selected according to a situation such as the cyan ink or the magenta ink.

Here, the edge processing of the present embodiment will be described. Hereinafter, a range with a thickness of one pixel which surrounds the area to which the black ink is applied is referred to as an “edge area”, and the reduction processing is performed for reducing the multivalued data of the chromatic color ink to be applied to this edge area.

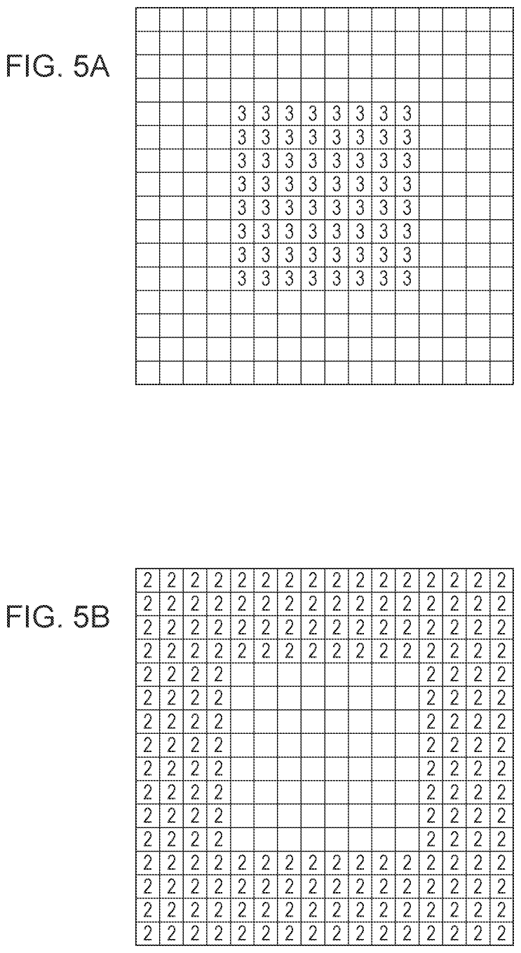

FIGS. 5A and 5B illustrate image data after 2-bit quantization of the black ink and the cyan ink. Each of the pixels of image data after the 2-bit quantization is represented by four tones, and four grayscale values “0”, “1”, “2”, and “3” indicate the number of ink dots to be applied to the pixel. In FIGS. 5A and 5B, a pixel having the grayscale value of “0” is represented in blank, and with regard to a pixel having the grayscale value of “1”, “2”, or “3”, the value is specified in the pixel.

FIG. 5A illustrates 2-bit multivalued data of the black ink, and FIG. 5B illustrates 2-bit multivalued data of the cyan ink. The 2-bit multivalued data of the black ink indicates that three dots of the ink are to be applied to each of the pixels corresponding to 8 pixels high×8 pixels wide in a central section, and the ink is not applied to surroundings of the central section. On the other hand, the 2-bit multivalued data of the cyan ink indicates that two dots of the ink are to be applied to each of the pixels in an area to which the black ink is not to be applied. In this case, in a boundary section between the area to which the black ink is to be applied and the area to which the cyan ink is to be applied, both types of the ink are mixed with each other, and the black ink bleeding onto a cyan ink side may be visually recognized as bleeding of the image.

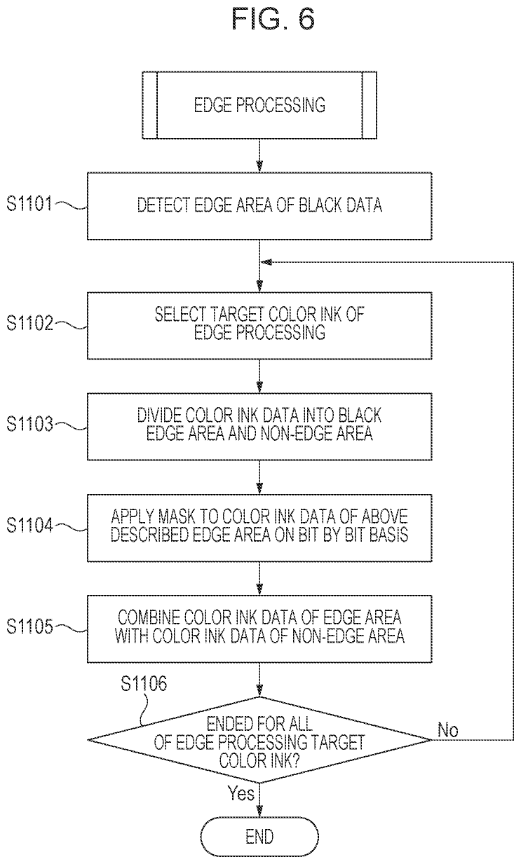

FIG. 6 is a flowchart illustrating a procedure of the edge processing according to the present embodiment. In step S1101, the edge area of the black ink is detected. To reduce the data of the chromatic color ink in the surroundings of the black ink according to the present embodiment, an area having the thickness of one pixel on an outer side of the pixels to which the black ink is to be applied is set as the edge area. When the edge area is to be detected, first, pixels having the pixel value of the black ink of “1” or higher are detected. Then, a thickened range through a bold process on the area to which the black ink is to be applied by a thickness of one pixel is set as the edge area.

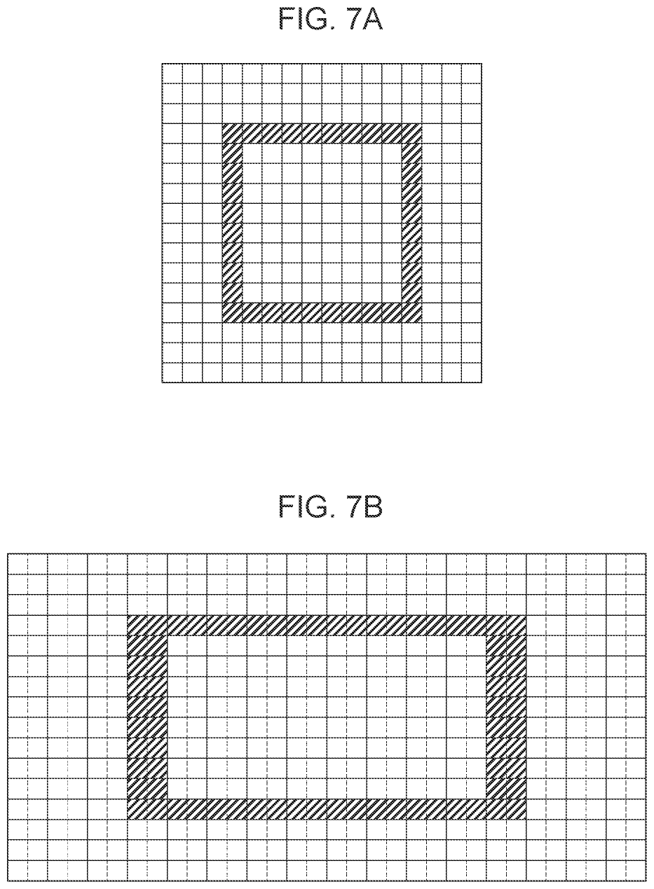

FIG. 7A illustrates the edge area corresponding to pixels marked with diagonal lines. In step S1102, chromatic color ink to be set as a target of the edge processing is selected. According to the present embodiment, cyan ink is selected. It is noted that as illustrated in step S1106 which will be described below, the similar reduction processing can also be repeatedly performed on chromatic color ink other than cyan.

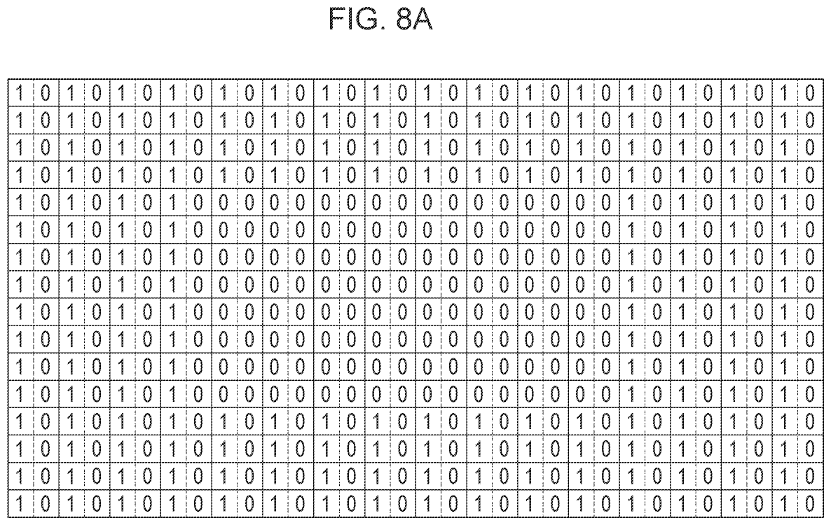

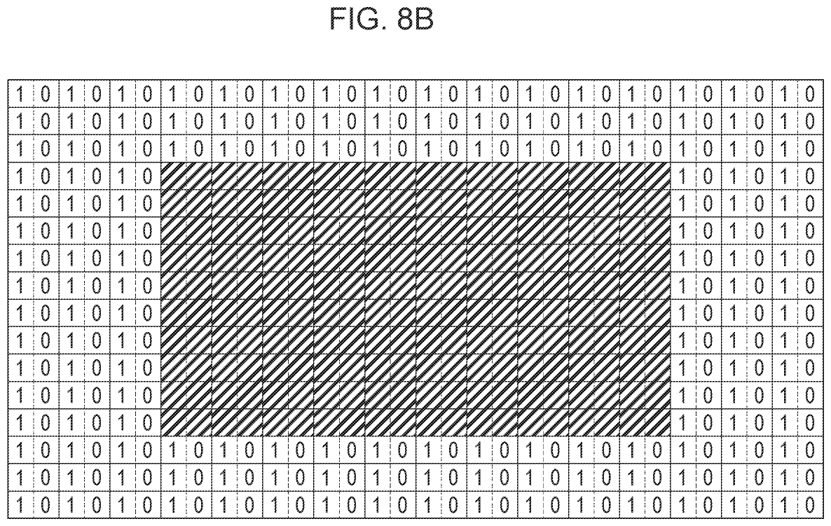

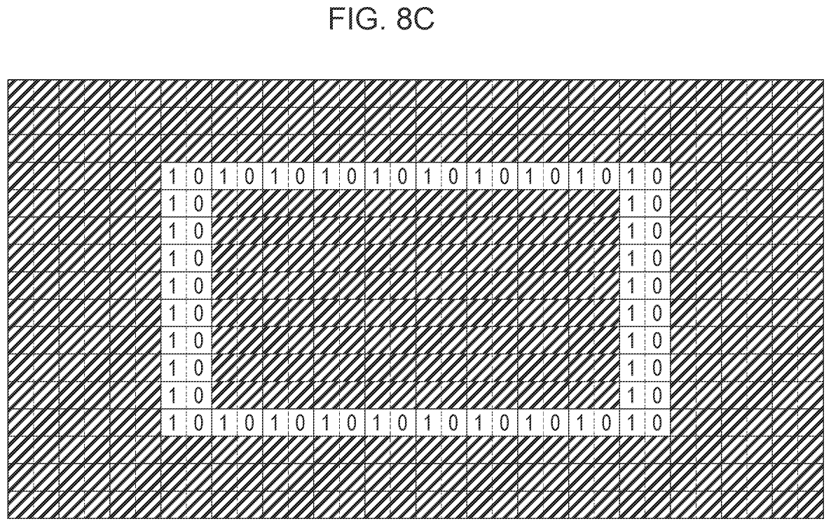

FIG. 8A illustrates the 2-bit multivalued data of the cyan ink selected in step S1102, which is held as such bit data on the memory. In FIG. 8A, a range surrounded by a bold frame represents a single pixel and is divided by a dotted line. A left hand side represents a bit on an upper-order side of the 2-bit data, and a right hand side represents a lower-order bit. As illustrated in FIG. 5B, with regard to the grayscale value of the cyan ink data, the pixel to which the black ink is not applied is “2”, and the pixel to which the black ink is applied is “0”. Therefore, with regard to the bit data of the respective pixels, the pixel with the grayscale value of “2” is “10”, and the pixel with the grayscale value of “0” is “00”.

FIG. 7B illustrates the 2-bit multivalued data of the black ink on the memory, and a range marked with diagonal lines represents the edge area. According to the present embodiment, since the 2-bit data per pixel is consecutively arranged in a scanning direction in the memory, an area multiplied in the scanning direction is set as the edge area.

Next, in step S1103, the image data of the cyan ink is divided into image data corresponding to the edge area and image data corresponding to an area other than the edge area. FIG. 8B illustrates bit data indicating an area other than the edge area that is an area to which the cyan ink is applied, and an area other than the above-described area is marked with diagonal lines. FIG. 8C illustrates bit data of the cyan ink pertinent to the edge area, and an area other than the above-described area is marked with diagonal lines.

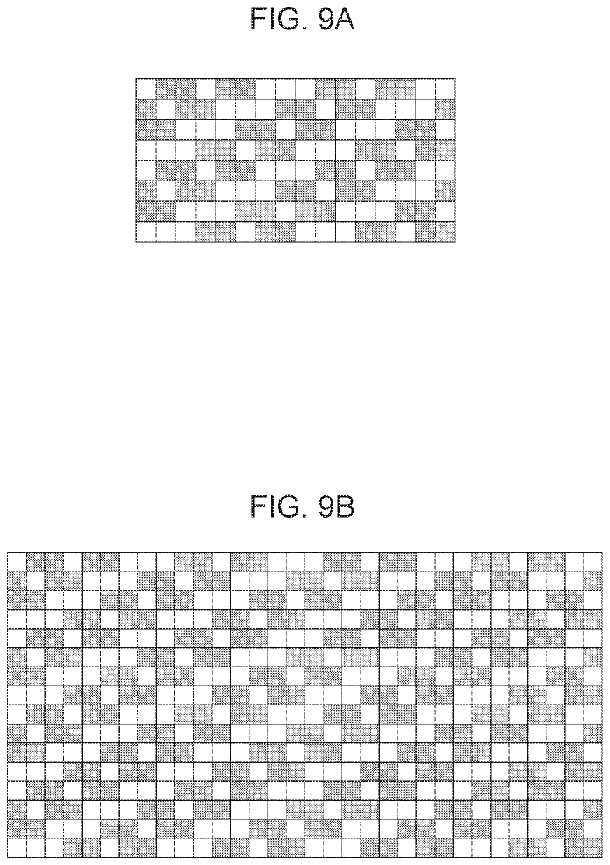

In step S1104, the reduction processing on the edge area is performed. According to the present embodiment, thinning processing based on a mask pattern is performed on the above-described bit data of FIG. 8C. FIG. 9A illustrates the mask pattern used for the thinning processing. Data after the thinning processing is generated by implementing an AND operation on this mask pattern and the pixels corresponding to the bit data of the cyan ink. In this thinning processing, the bit of the image data corresponding to the bit marked with the mask pattern is unchanged, and the bit of the image data corresponding to a blank bit is changed to 0.

It is noted that when a size of units of the quantization processing in step S1003 of FIG. 3 is 16 pixels high and 16 pixels wide as illustrated in the drawing, the mask pattern is designated to have the same size as a processing area or a smaller size than the processing area (herein, 8 pixels high×8 pixels wide). With this configuration, an allocation position of the mask pattern is regularly fixed in units of the quantization processing. In the example of the present embodiment, the size can be matched with units of the quantization processing as illustrated in FIG. 9B by aligning and arranging two mask patterns each in the scanning direction and the conveyance direction. As a result, a local bias of a dot thinning rate after the reduction processing can be avoided, so that it is possible to suppress generation of an area where an edge processing effect is hardly attained because of a low dot thinning rate by the edge processing or suppress generation of a void due to excessive thinning.

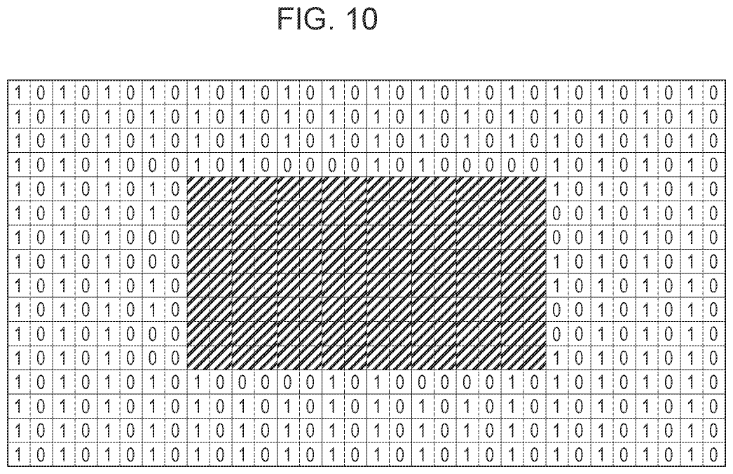

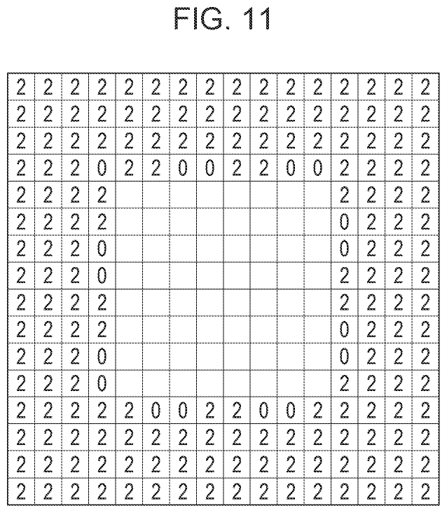

In step S1105, single data is generated by combining the data of the edge area which has been reduced using the mask pattern with the data of the area that is not the target of the reduction processing of FIG. 8B which has been separated. FIG. 10 illustrates bit data after the combination, and FIG. 11 illustrates data obtained by restoring the bit data on the memory to be multivalued. The pixels in the edge area among the pixels where the input grayscale value of cyan is “2” are categorized into two types after the reduction processing: pixels where the grayscale value remains “2” and pixels where the grayscale value has been reduced to “0”.

In step S1106, it is determined whether the edge processing is also ended on the image data other than the cyan ink. When the edge processing is not ended, the processing is also performed on the image data of the ink color set as the target of the edge processing, and when the edge processing is ended on the image data other than the cyan ink, since the edge processing is ended, the processing returns to the flow of FIG. 3.

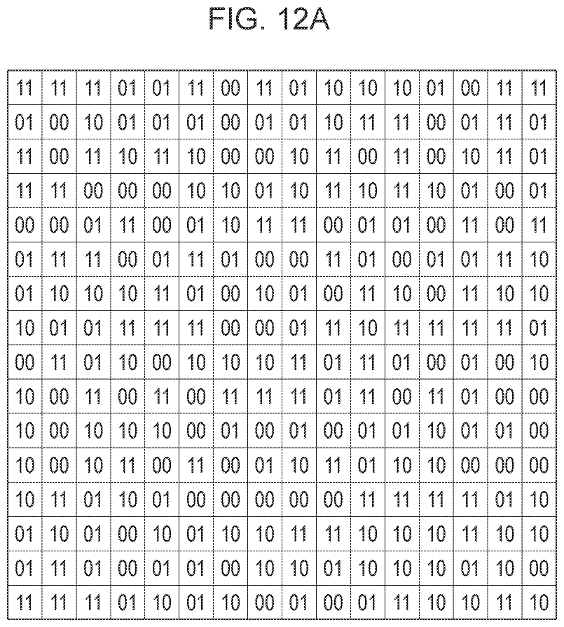

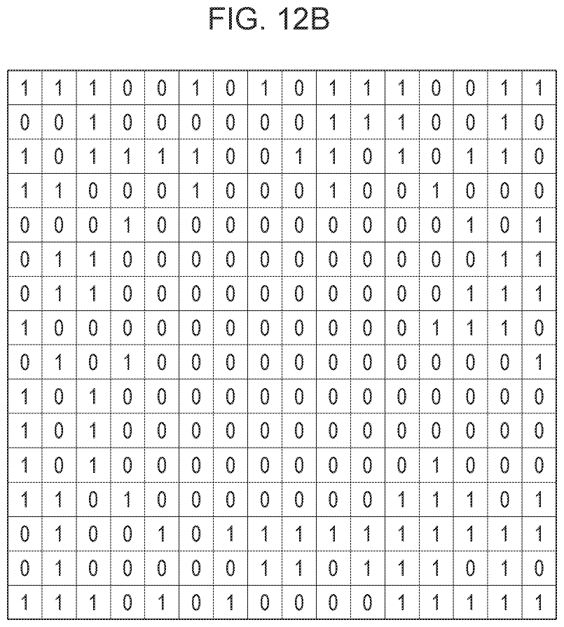

With reference to FIG. 3 again, in step S1005, the binarization processing is performed on the multivalued data on which the edge processing in step S1004 has been implemented. Herein, recording data that is recorded by a single scanning operation of the carriage to which the print heads are mounted is generated using the mask pattern as illustrated in FIG. 12A and the decode table illustrated in FIG. 4. According to the present embodiment, so-called multipass printing is performed in which recording of an image is completed by multiple operations of the carriage scanning over the unit area.

Herein, recording data is generated in which the multivalued data after the edge processing is to be used for the single scanning operation using the decode mask.

FIG. 12B illustrates a result obtained by performing the binarization processing using the mask pattern of FIG. 12A on the multivalued data of the cyan ink after the reduction processing. With regard to the pixel where the input grayscale value is “2”, “1” is selected as the binary data such that the pixel is recorded when the value of the mask pattern is “10” and “11”. Similarly as in the cyan ink, the binarization processing is performed on the image data of the other ink colors, based on the respective mask patterns. Then, recording data after the binarization processing is sent to the print heads 110 to 113, and ink droplets are discharged from the print heads 110 to 113, based on the recording data to record an image.

As described above, when the reduction processing is performed using the mask pattern on a bit by bit basis on the bit data quantized into M bits per pixel in the edge processing, it is possible to reduce the pixel value of the multivalued data of the edge area. As a result, the bleeding between the different ink types can be reduced while processing load associated with the reduction processing is suppressed.

### Second Embodiment

According to the above-described embodiment, the bit data is reduced by performing the thinning of the edge area using the single mask pattern. A thinning ratio of the mask pattern may be changed according to a grayscale value of quantization data of each of the pixels. In view of the above, according to the present embodiment, a method of adjusting a chromatic color ink thinning amount in the edge area by setting a mask pattern according to the grayscale value of each of the pixels in the image data of the chromatic color ink will be described.

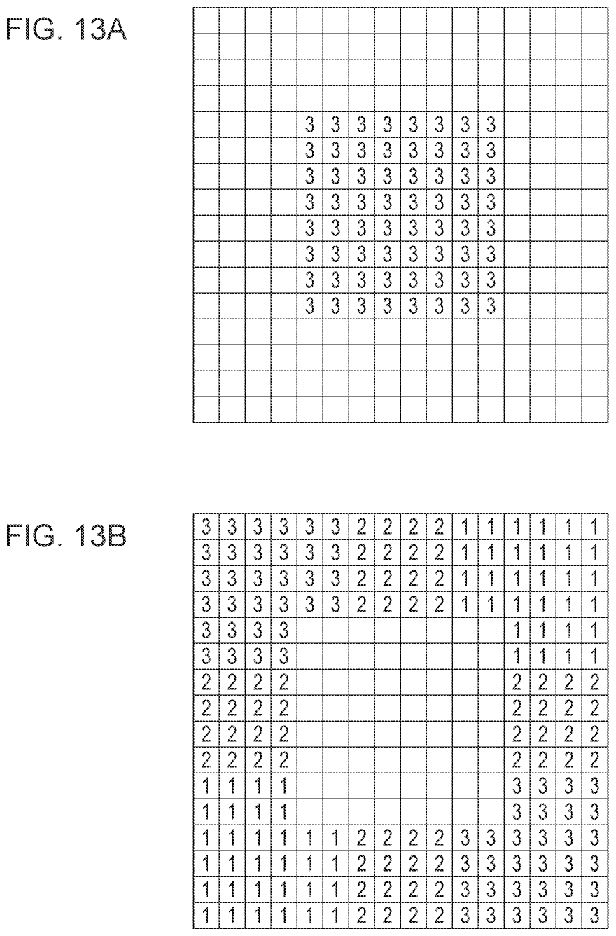

FIGS. 13A and 13B illustrate input multivalued image data of the present embodiment. FIG. 13A illustrates multivalued image data of black ink, and FIG. 13B illustrates multivalued image data of cyan ink.

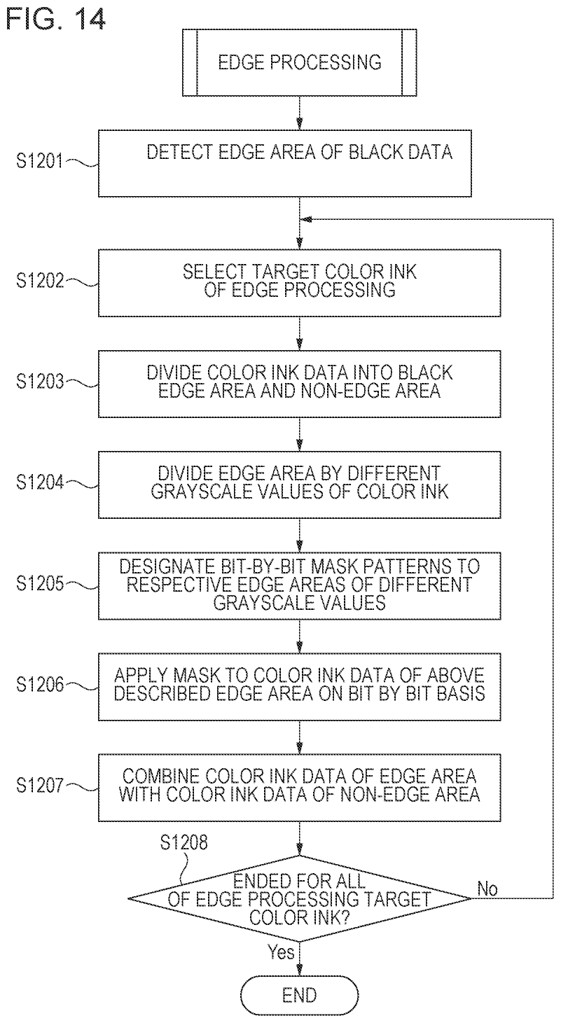

FIG. 14 is a flowchart of edge processing according to the present embodiment. First, in step S1201, an edge area of the black ink data is detected. The edge area of the black ink is set as the same area of the first embodiment as illustrated in FIG. 6.

Next, in step S1202, chromatic color ink data on which the edge processing is to be performed is selected. Herein, the cyan ink is selected. In step S1203, the image data of the cyan ink is divided into edge area data and non-edge area data other than the edge area. A division method is similar to that of the above-described embodiment. In step S1204, the area is further divided according to the grayscale value of each of the pixels included in the edge area to generate image data according to the grayscale value, and in step S1205, mask patterns at corresponding thinning rates are set for respective pieces of the image data of the different grayscale values.

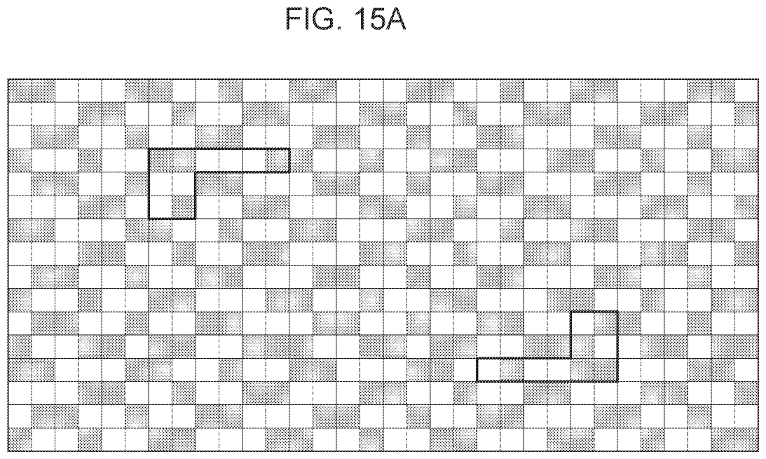

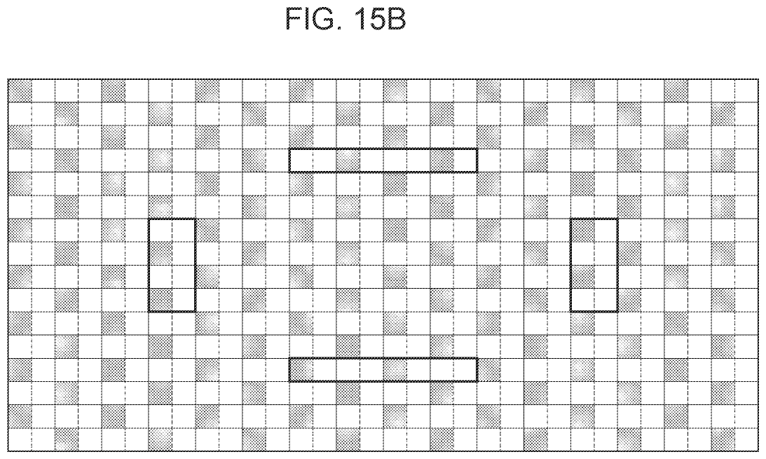

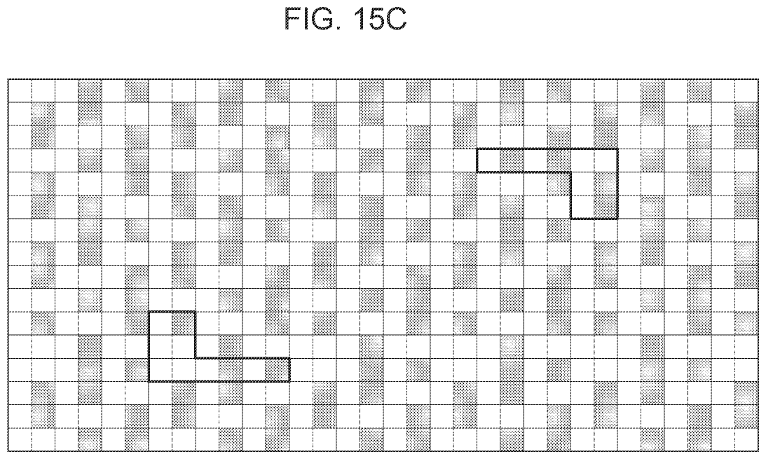

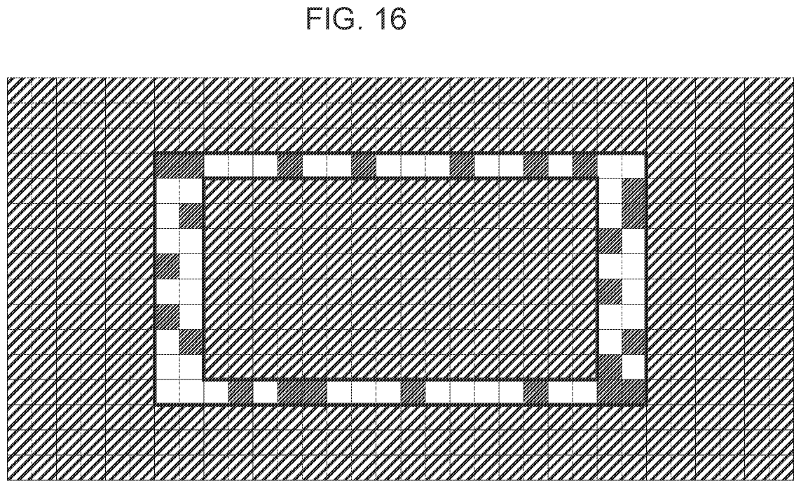

FIGS. 15A, 15B, and 15C illustrate mask patterns used for bit data. FIG. 15A illustrates the mask pattern applied to the pixel where the grayscale value is “3”, and the pixel marked in white indicates a bit position where the data is to be thinned out. An area surrounded by a bold line indicates an area where the grayscale value is “3” in input image data of the cyan ink. Similarly, FIG. 15B illustrates the mask pattern applied to the pixel where the grayscale value is “2”, and FIG. 15C illustrates the mask pattern applied to the pixel where the grayscale value is “1”.

Herein, it is sufficient when the mask pattern having the grayscale value of “2” masks one upper-order bit of each of the pixels, and it is sufficient when the mask pattern having the grayscale value of “1” masks one lower-order bit of each of the pixels. FIGS. 15B and 15C illustrate the mask patterns biased to any of the bits, but the bits on which the thinning processing is not performed do not affect a result of the edge processing, and therefore it is optional as to whether the thinning is to be performed. According to the present embodiment, the mask pattern is designated while it is assumed that the thinning is to be performed. The mask pattern of each of the pixels surrounded by bold frames is selected, and the pattern for masking the bit data in the end is as illustrated in FIG. 16.

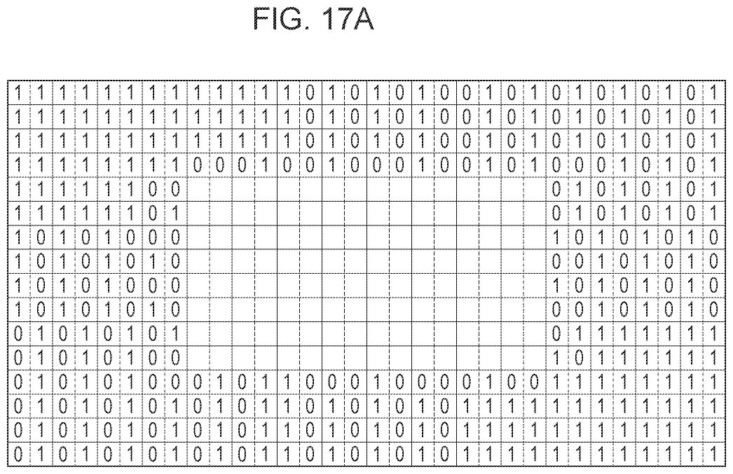

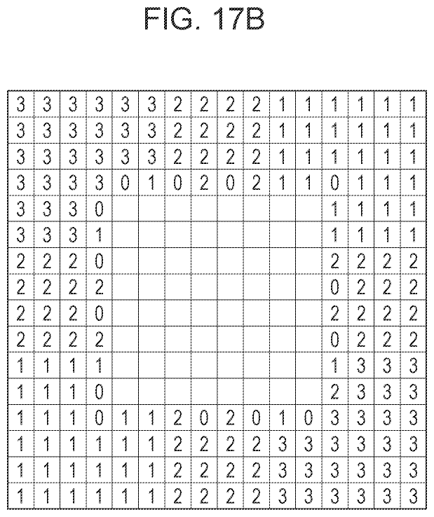

In step S1206, the thinning processing is performed using the mask pattern of FIG. 16 described above on the input bit data of cyan, and the bit data of the edge area is combined with the bit data of the non-edge area in step S1207. FIG. 17A illustrates the combined bit data, and FIG. 17B illustrates data obtained by restoring the data to be multivalued from the bit data.

As described above, the mask pattern is set such that with regard to the pixels of the cyan ink which are adjacent to the pixels to which the black ink is to be applied, the pixel where the number of application dots is higher has a higher ratio of the reduction processing. According to the present embodiment, the pixels where the input grayscale value is “3” are subjected to such thinning that the number of dots is to be fewer than the half (approximately 40%). The pixels where the input grayscale value is “2” are subjected to such thinning that the number of dots is substantially halved. The pixels where the input grayscale value is “1” are subjected to such thinning that the number of dots are left to be more than the half (approximately 65%). As a result, the thinning rate is higher as the pixel has a higher number of dots at a boundary section between the black ink and the cyan ink, and it is possible to suppress bleeding at the boundary section. Furthermore, since the thinning rate of the dots is lower as the pixel has a lower number of application dots where the bleeding causes little effect, it is possible to suppress generation of a void at the boundary section due to excessive thinning of the dots.

When the reduction processing using the mask patterns for the bit data for the different grayscale values as described above is implemented, as compared with a case where subtraction processing is performed according to the grayscale value for each pixel, the ink application amount can be appropriately reduced while the processing load is alleviated.

### Third Embodiment

In image data converted to have M bits, a specific bit of the data with the M bits may have information of an attribute (such as a character or a line) of an image. In the edge processing described according to the above embodiment, since information desired to be referred to is the grayscale value of each of the pixels, the reduction processing is to be performed on specific bit data at the time of the edge processing. In view of the above, according to the present embodiment, a case will be described where a most significant bit is attribute information in the quantization data when M is higher than or equal to 3.

In the following description, M=3 is set, and two lower-order bits are set as grayscale value information.

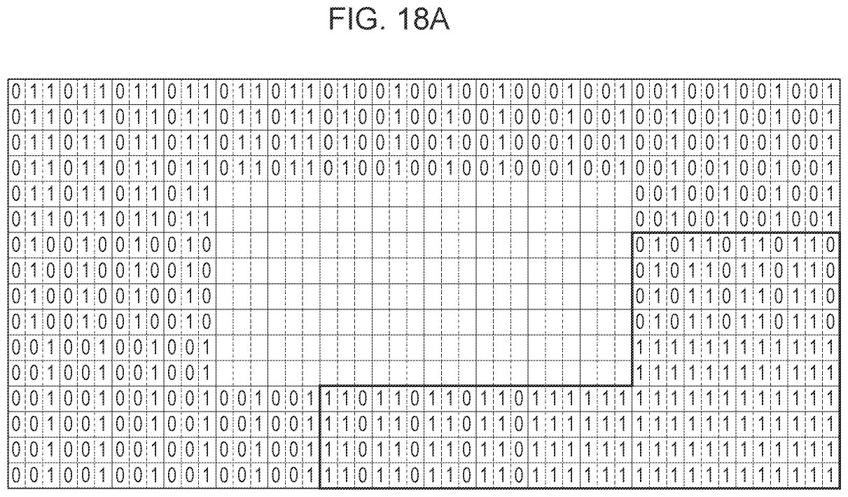

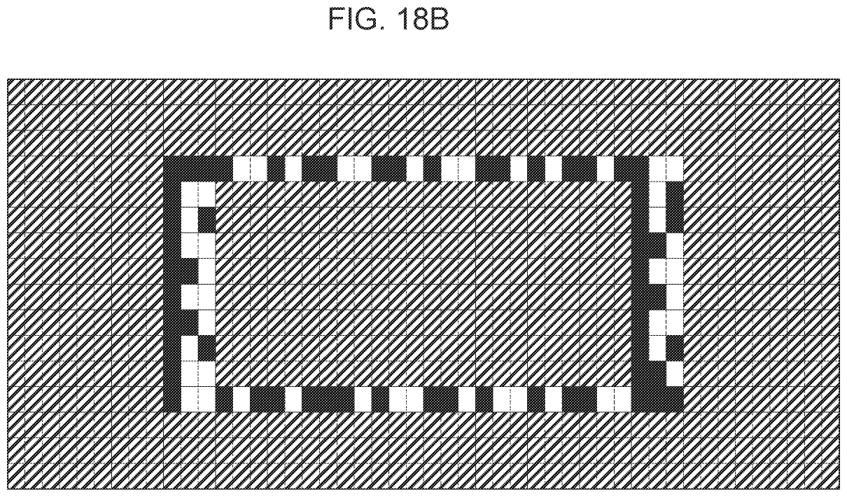

FIG. 18A illustrates image data of the cyan ink according to the present embodiment which is represented on a bit by bit basis. The grayscale values are the same as the data illustrated in FIG. 13B, but a most significant bit of pixels surrounded by a thick black frame on a lower right side is attribute information, which corresponds to 1 in an example of FIG. 18A. It is noted that although the data of the black ink is not illustrated, but the edge area is set as the same range of the pixels illustrated in FIGS. 7A and 7B.

According to the present embodiment too, the processing is similarly performed as in the flow of FIG. 14 illustrated according to the second embodiment, but since the most significant bit is not tone information, the information is not to be deleted in a mask process of the edge processing flow. In other words, only the grayscale value can be reduced by setting a mask pattern with which only the two lower-order bits representing the grayscale value are thinned out at a predetermined ratio, but the most significant bit is not thinned out. FIG. 18B illustrates a mask pattern used in the present embodiment, and a thinning ratio of the grayscale value section is set according to the grayscale value as illustrated in FIG. 16, and it is set that the most significant bit is not to be thinned out. It is noted that herein, the thinning ratio based on the edge processing does not relay on a value of the most significant bit, but when the thinning mask pattern is to be switched depending on the pixel value, the pixel where the thinning processing is not to be performed may be selected depending on the value of the most significant bit, and the thinning ratio of two lower-order bits may be switched.

With the above-described processing, the attribute information of the image is held even after the edge processing. The submatrix pattern can be switched at the time of the binarization processing in step S1005 depending on a value of the most significant bit indicating the held attribute information of the image, or the mask pattern can be switched by a combination with the decode table. Specifically, when a value of the bit indicating the attribute information is “1”, in the binarization processing based on the submatrix pattern, a ratio of dots to be recorded by specific scanning can be increased. Alternatively, in the binarization processing using the mask pattern, the mask pattern can be switched such that a ratio of the recording by the specific scanning is increased in a distribution ratio to multiple scanning operations in the combination with the decode table of FIG. 4. Even in a case where behaviors of ink of a plurality of colors at the time of permeation into the recording medium are affected by a recording order to cause an issue such as irregular color, gloss unevenness, or bleeding, the above-described issue can be suppressed by controlling the recording order among the ink colors by the method described above.

In this manner, the attribute information included in the multivalued data of each of the pixels can be held at the time of the edge processing while the load associated with the edge processing on the multivalued image data is suppressed, and the attribute information can also be used in the binarization processing after the edge processing.

### Other Embodiments

According to the above-described embodiment, the configuration is adopted where the section with the thickness of the one pixel on the chromatic color ink side in the boundary area where the black ink is adjacent to chromatic color ink is set as the edge area to thin out the bit data to reduce the application amount of the chromatic color ink, but the target of the reduction processing is not limited to the above-described method. A configuration may also be adopted where the application amount on the black ink side is thinned out, and in this case, an end portion of the area to which the black ink is to be applied may be set as the edge area.

In addition, the pixels set as the target of the reduction processing are not limited to areas with different ink colors which are adjacent to each other.

For example, in a character image or a line drawing image, to suppress bleeding of ink at a contour portion into a blank area on paper to which the ink is not applied, a boundary area of an object such as characters or line drawings may be set as the target of the reduction processing. Either one or both of pixels to which the ink on an inner side of the boundary area is applied and pixels to which the ink on an outer side of the boundary area is not applied may be appropriately set as the edge area. In addition, to improve fixability of the ink, an inner area (non-edge area) of the characters or the line drawings may be set as the target of the reduction processing. Moreover, when a full surface of the image data is to be thinned out, the processing for identifying the target pixels of the reduction processing may be omitted, and the mask pattern may be applied to all the pieces of bit data to perform the thinning processing. The target pixels of the reduction processing are not limited to these examples, and may be appropriately selected.

According to the embodiments of the disclosure, when the mask pattern is used for the bit data of M bits (M≥2) per pixel, the reduction processing can be performed while the increase in the processing load is suppressed.

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-060647 filed Mar. 31, 2021, which is hereby incorporated by reference herein in its entirety.

What is claimed is:

1. An apparatus comprising:
an identification unit configured to identify, in L-tonal (L≥3) image data in which each of pixels is represented by bit data of M bits (M≥2), a target pixel on which reduction processing is to be executed; and
a reduction processing unit configured to reduce a grayscale value of the identified target pixel, wherein
the reduction processing unit reduces the grayscale value, based on the bit data of M bits corresponding to the target pixel and mask pattern data corresponding to the target pixel.

2. The apparatus according to claim 1, wherein the reduction processing unit reduces the grayscale value by implementing an AND operation on each piece of bit data of M bits which represents a target pixel identified and each piece of bit data of M bits of the mask pattern data corresponding to the target pixel.

3. The apparatus according to claim 1, wherein the image data includes first image data for application of ink of a first color and second image data for application of ink of a second color.

4. The apparatus according to claim 3, wherein the identification unit identifies, as the target pixel of the reduction processing, an N pixel or N pixels (N≥1) in the second image data which is or are adjacent to a pixel indicating that the first ink is to be applied to the pixel in the first image data.

5. The apparatus according to claim 1, wherein the identification unit identifies, as the target pixel of the reduction processing, a pixel corresponding to a boundary area of an object in the image data.

6. The apparatus according to claim 1, further comprising:
a generation unit configured to generate recording data indicating recording or non-recording of the image data on which the reduction processing has been executed.

7. The apparatus according to claim 6, wherein the recording data is one-bit binary data.

8. The apparatus according to claim 1, further comprising:
a quantization unit configured to generate the L-tonal image data by quantizing multivalued image data.

9. The apparatus according to claim 1, wherein the reduction processing unit sets the mask pattern data to be used from among plural pieces of mask pattern data according to the grayscale value of the identified target pixel.

10. The apparatus according to claim 1, further comprising:
a recording unit configured to record an image on a recording medium, based on the image data on which the reduction processing has been executed.

11. A method comprising:
identifying, in L-tonal (L≥3) image data in which each of pixels is represented by bit data of M bits (M≥2), a target pixel of reduction processing; and
reducing a grayscale value of the identified target pixel, wherein
the reducing includes reducing the grayscale value, based on the bit data of M bits corresponding to the target pixel and mask pattern data corresponding to the target pixel.

12. The method according to claim 11, wherein the reducing reduces the grayscale value by implementing an AND operation on each piece of bit data of M bits which represents a target pixel identified and each piece of bit data of M bits of the mask pattern data corresponding to the target pixel.

13. The method according to claim 11, wherein the image data includes first image data for application of ink of a first color and second image data for application of ink of a second color.

14. The method according to claim 11, wherein the identifying identifies, as the target pixel of the reduction processing, a pixel corresponding to a boundary area of an object in the image data.

15. A non-transitory computer-readable storage medium storing a program for causing a computer to execute:
identifying, in L-tonal (L≥3) image data in which each of pixels is represented by bit data of M bits (M≥2), a target pixel of reduction processing; and
reducing a grayscale value of identified the target, wherein
the reducing includes reducing the grayscale value, based on the bit data of M bits corresponding to the target pixel and mask pattern data corresponding to the target pixel.

16. The non-transitory computer-readable storage medium according to claim 15, wherein the reducing reduces the grayscale value by implementing an AND operation on each piece of bit data of M bits which represents a target pixel identified and each piece of bit data of M bits of the mask pattern data corresponding to the target pixel.

17. The non-transitory computer-readable storage medium according to claim 15, wherein the image data includes first image data for application of ink of a first color and second image data for application of ink of a second color.

18. The non-transitory computer-readable storage medium according to claim 15, wherein the identifying identifies, as the target pixel of the reduction processing, a pixel corresponding to a boundary area of an object in the image data.

19. An apparatus comprising:
an obtaining unit configured to obtain image data having an L-tonal (L≥3) grayscale value in which each of pixels is represented by information of M bits (M≥2); and
a reduction processing unit configured to perform reduction processing for reducing the grayscale value by implementing an AND operation on the image data obtained by the obtaining unit and mask pattern data.

20. A method comprising:
implementing an AND operation on image data having an L-tonal (L≥3) grayscale value in which each of pixels is represented by information of M bits (M≥2) and mask pattern data to perform reduction processing for reducing the grayscale value.
